(19) United States
(12) Patent Application Publication
(10) Pub. No.: US 2015/0088779 A1
(43) Pub. Date: Mar. 26, 2015

(54) Food Delivery Service

(71) Applicant: Gruppo Due Mondi, Inc., Wakefield, NH (US)

(72) Inventors: Richard Falcone, Wakefield, NH (US); John J. Viola, Frisco, TX (US); Dennis J. Reinhold, Dallas, TX (US)

(21) Appl. No.: 14/036,132

(22) Filed: Sep. 25, 2013

(51) Int. Cl. G06Q 10/08

(52) U.S. Cl. CPC G06Q 10/083
USPC 705/330

(57) ABSTRACT

Embodiments provide an integrated real-time, customer-company process that materially improves the end-to-end customer experience for delivery of products and services. The invention enables more efficient management of a company's supply-demand relationship, unit costs, and return on investment. Example embodiments are directed to an inter-related, customer-company management process for a food delivery business. A process on an intelligent, processor-based platform provides an improved end-to-end customer experience, for example, by reducing wait times and using convenient payment options so that customer does not need to handle money. The process further enables a food truck operator to more efficiently manage the business, both at a single site and across multiple sites. There is a substantial, real-time interdependency between the customers and the food truck operator. The process provides ongoing Just-in-Time order status information to customers and ongoing Just-in-Time operating and cooking instructions to the food truck operator.

### BACKGROUND

Employees often have limited options for their lunch break due to their work location and/or the amount of time they are allowed for lunch. For example, people who work in an office building may have access to a cafeteria or sandwich shop in the building, but there may be no other restaurants nearby. As a result, the employees may have limited lunch choices, such as bringing their own lunch or eating at the same place every day.

When employees do decide to use an on-site cafeteria or sandwich shop they often find that they are caught in the lunchtime rush with many other employees in the building who are all trying to get served at the same time. This often leads to employees waiting in lines to be seated and/or served. The wait time can be unpredictable and varies depending upon who many other employees decided to use the on-site facilities that day. Similar delays and waiting lines are also experienced at off-site locations, which further include delays caused by driving to the off-site locations.

When an employee is served during a lunchtime rush, the food quality often varies depending upon the number of customers and the facility's ability to serve the customer load. The employee often receives re-warmed food from a buffet or steam table instead of freshly prepared, hot out of the oven food.

Additional delays during lunchtime food service occur when customers pay. The employee/customer pays the server, cashier, or cook, who has to process the payment and handle the cash register or credit card reader. This introduces an unhygienic element to the lunch service. There is a need to pre-pay for employee lunch service to improve service time and reduce the number of people who have to handle a transaction.

Food trucks that offer different types of standard and gourmet foods may serve office buildings and other commercial locations for lunchtime meals. These food trucks provide some variety to the employees at these locations. However, limited time for the employee's lunch break and municipal regulations that restrict how long a food truck can sell in one location can make it difficult for employees to take advantage of the food trucks that visit their worksite.

Food trucks offer convenience and help address employee's limited time for lunch, but the customers do not know if they are going to have to wait in line for a food truck. The need for customers to wait in line can be a random event and may require them to wait in the hot sun, in cold weather, or in rain. Additionally, the food truck may not have the customer's desired food choice available at the window when the customer makes their order. Food truck items may also be prepared ahead of time and need to be re-warmed when served so that they are not fresh. Further delays may occur in payment methods. Food trucks typically require cash, which adds time to the duration required to complete each service.

### SUMMARY

In one embodiment, the invention provides an integrated real-time, customer-company process that materially improves the end-to-end customer experience and enables more efficient management of a company's supply-demand relationship, unit costs, and return on investment. The customer referred to herein may be an employee at a business location that is a target for a luncheon food service.

The invention is directed to an inter-related, customer-company management process for a luncheon food delivery business. A process on an intelligent, processor-based platform provides an improved end-to-end customer experience, for example, by reducing wait times and using convenient payment options so that customer does not need to handle money. The process further enables a food truck operator to more efficiently manage the business, both at a single site and across multiple sites. There is a substantial, real-time interdependency between the customers and the food truck operator. The process provides ongoing Just-in-Time order status information to customers and ongoing Just-in-Time operating and cooking instructions to the food truck operator. Point of sale data is collected and is used to provide management reports and other key business function input, such as data used to prepare financial statements.

Embodiments of the invention are directed to improving service and availability for employees in the context of a luncheon business environment. Embodiments are further directed to improving efficiency and reducing time wasted by food truck operators.

A customer-centric luncheon sub-process of a food truck operation is designed to enable simple, effective and convenient:
(1) customer ordering before the food truck or mobile operating unit arrives at the customer's worksite;
(2) individual customer fulfillment;
(3) a specific time commitment for fulfillment of customer pre-orders; and
(4) payment.

In addition, the luncheon sub-process provides a real quantifiable benefit to the tenants of a target office building without any cost to the owner or management company of the building.

The luncheon sub-process may utilize a time-slotting approach that is designed to create an opportunity for customers to conveniently place and obtain a lunch order with a minimum of wasted time.

The luncheon sub-process utilizes interactive, mobile technologies to enable customers to conveniently place orders and to receive just-in-time (JIT) communications that are driven by an intelligent processor-based platform that manages a supply-demand process. The food truck or mobile operating unit (MOU) may also use JIT instructions delivered to the chef or operator by the intelligent processor-based platform.

Examples of mobile food truck systems for providing the services described herein are disclosed in pending U.S. patent application Ser. No. 13/875,205, titled “Optimizing Customer Deliver Services,” the disclosure of which is hereby incorporated by reference herein in its entirety.

In one embodiment, the lunchtime sub-process establishes an end-to-end customer luncheon experience that is similar to a home-delivery or dinner service experience as contemplated in the referenced patent.

The luncheon sub-process creates a new and improved, end-to-end, electronically-based customer experience that benefits both customers and the food truck operator.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating a system for providing intelligent processor-based platform and luncheon sub-process for food delivery truck operators according to one embodiment.

FIG. 2 illustrates an integrated delivery platform according to one embodiment that provides delivery services to multiple markets.

FIG. 3 is a flowchart illustrating one a process for providing food service to customers at a selected location according to one embodiment.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

An opportunity exists for luncheon delivery food business to provide a luncheon service to business-employee customers. The luncheon delivery service reduces wasted time by the customer and to more efficiently organize workloads for the food truck staff and operator. Additionally, food truck operator time-management is improved (i.e., by reducing wasted minutes) across multiple businesses and/or other locations by considering cumulative historical and/or current demand information. As a result of the time management efficiencies using the luncheon sub-process, a food truck operator can improve margins and profitability. The end-to-end customer luncheon experience is also improved.

The food truck operator can provide both a luncheon service (luncheon sub-process) as described herein for customers at work locations and an evening service (dinner sub-process) for customers and consumers at home or other locations.

The luncheon sub-process notifies customers, as applicable, regarding their individual order status. Additionally, customers who have not submitted prior orders may be notified as to when a food truck will be arriving and departing, as well as the availability of the food truck for open service. Additional notifications, such as specials, first-time and/or repeat customer discounts and incentives, sales, menu-item availability (e.g., sold out, available for x-minutes more, only x servings left, etc.), may be sent to customers.

The luncheon sub-process can identify or cluster orders by fulfillment commitment times, which are specific times, intervals, or fulfillment commitment times when the orders will be ready for pickup or delivery. An intelligent processor-based platform (e.g., a processor-based food truck management service or “brain”) running the luncheon sub-process can use the fulfillment commitment times to determine how long to stay in one location. For example, based on any number of considerations, the luncheon sub-process brain decides, within some calculated envelope, whether to stay longer at a current location or to leave earlier than originally scheduled or expected. In the case where the food truck leaves earlier or later than expected, the luncheon sub-process can dynamically notify a next location, and the customers at that next location, as to an updated arrival time.

The luncheon sub-process considers the likelihood of total demand volume from all sources, such as pre-orders and on-site orders from customers waiting in line. The luncheon sub-process also considers data regarding previous demand at the current location and the likelihood of demand at the next planned business location. The luncheon sub-process uses this predicted or estimated demand together with current demand data when evaluating how long to stay in one location.

The luncheon sub-process operates in the background while the intelligent processor-based platform is processing customer orders, providing instructions to the food truck operator and staff, etc. and is oriented to ensuring that the food truck wastes no time in providing food service at various locations.

Using this innovation, customers who have pre-ordered items from the food truck and/or special repeat or elite customers may be assigned to a first set of fulfillment commitment times corresponding to the food truck's arrival time at the location. Other customers (e.g., walk-up business) may be notified when a general lunch service will begin so that pre-orders may be served first. This scheduling may inherently incentivize pre-ordering, repeat ordering, and may also reduce wait time for all customers whether or not they pre-order.

Given that different customers will want different luncheon orders, but will also arrive randomly in the food ordering line, the current fulfillment approach for the food truck industry is challenging and inherently inefficient. The current process is not optimized for the customer and is unnecessarily costly to the food truck operator.

To increase the tastiness and appeal to the customer, it is preferable to offer “just cooked” or “hot out of the oven” food products. For example, in the case of pizza, it is best to provide each customer with a “bubbling-hot” (as opposed to warming-oven warm) pizza. Requiring customers to queue-up in ordering lines serves to reduce the chance of meeting the “just cooked” or “hot out of the oven” benefit.

A luncheon sub-process that manages time and workflow can be used to provide:
(1) a tastier and more appealing food product to the customer;
(2) a reduction in customer wasted time;
(3) a more common experience between luncheon and evening/home business;
(4) a more efficient food service operation for food truck staff and operators;
(5) an improved end-to-end customer experience; and
(6) improved margins and profitability for the food truck operator.

The luncheon sub-process provides a more convenient, customer ordering, fulfillment, and payment experience. The process also uses technology to provide just-in-time preparation and cooking instructions to the food truck operator and staff.

The luncheon sub-process efficiently organizes work into fulfillment commitment times for clusters of similar orders. The luncheon sub-process communicates with the customer on a JIT-basis to reduce unnecessary waiting in line. The luncheon sub-process also provides JIT cooking information to the chef and/or food truck staff.

The luncheon sub-process also contemplates and accommodates two additional conditions:
(1) some customers may not have time, or may not choose, to utilize an improved pre-ordering process; and
(2) some customers will want to submit unique or special orders.

Accordingly, the luncheon sub-process is dynamic such that each business location may have different customer orders each time. The intelligent processor-based platform (e.g., a processor-based food truck management service or “brain”) coupled with interactive mobile devices (e.g., smartphones, tablet computers, personal digital assistants, etc.) are used to efficiently manage such situations.

Although referred to herein as a “luncheon sub-process” the process may be given any appropriate name, such as a reference to a principal advantage to the customer (e.g., “TimeSaver,” “FastTake,” “PRONTO,” etc.).

Embodiments of the luncheon sub-process take into account and recognize that some customers will take advantage of process but others will not. Accordingly, both pre-order and walk-up customers may be served. It may be practical to establish a set of standard food orders for some or all locations to optimize the food truck operator's ability to efficiently serve customers. Additionally, the luncheon sub-process may cluster standard orders into time slots for a given business location and/or visit.

A food truck visit to a particular business location may be organized into two or more fulfillment commitment times. For example, a first fulfillment commitment times may be assigned to standard pre-orders; a second fulfillment commitment times is assigned to all special orders; and a third fulfillment commitment times is assigned to walk-up service (i.e., not pre-ordered).

The intelligent processor-based platform and luncheon sub-process may organize orders into a cluster and assign the clusters of orders into fulfillment commitment times. For example, all plain and pepperoni pre-orders for a pizza food truck may be grouped into a cluster that is assigned to a fulfillment commitment time. The customers associated with those orders are then sent a message (e.g., text, email, call) notifying them of a pickup time for the orders, wherein the pickup time corresponds to the first fulfillment commitment time.

The luncheon sub-process may be designed such that, the intelligent processor-based platform automatically organizes and schedules pre-orders into fulfillment commitment times. The intelligent processor-based platform then:
(1) notifies customers of a pre-order pick up time; and
(2) provides JIT cooking instructions for the pre-orders to a chef or food truck staff.

The JIT cooking instructions operate to reduce randomness of order preparation and chef work effort. The cooking instructions may include, for example, information such as ingredients and recipes, reminders such as when to start order preparation, start cooking orders, or remove orders from an oven. The JIT cooking instructions may be provided via a tablet, computer, or terminal on the food truck.

The luncheon sub-process and lunchtime business for customers follows a similar approach as is utilized for an evening dinner business and provides many of the same benefits, such as:
(1) pre-order customers know when they will be served;
(2) customers will get hotter, fresher product; and
(3) order fulfillment timing and payment are all interactively facilitated electronically.

The timing for customer order fulfillment (i.e., pre-order pickup) is specifically set and communicated to the customer. Even customers who have not preordered will have a shorter wait time. The period during which spontaneous or walk-up orders are accepted may be reduced in order to fulfill pre-orders; however, customers at the location are notified in advance regarding when an open, walk-up service will begin.

The use of JIT instructions to the food truck chef/staff and JIT communications to the customers allow the intelligent processor-based platform to operate more efficiently. The intelligent processor-based platform and luncheon sub-process may make real-time recommendations to the food truck operator regarding appropriate service times at a given location (e.g., arrival and departure times). Over time and with additional actual experience at each location, the intelligent processor-based platform and luncheon sub-process may learn how particular groups of customers act and the process may fine tune itself.

The intelligent processor-based platform may actively enable further management and/or a variety of actions at a particular luncheon site or across multiple luncheon sites depending on real-time data. In particular, real-time demand volume data may be used by the intelligent processor-based platform to control how the food trucks are deployed. For example, the intelligent processor-based platform may act not only on the basis of historical demand volume at a given site, but it may also assess demand volume in real-time.

A luncheon site may have an average demand volume of X, but for whatever reason on a given day that site may have a volume that is only 60% of the typical actual historical volume (i.e., demand is only 60% of X). In such a case, the intelligent processor-based platform may undertake any number of possible actions so as to not waste any time at that location. For example, the intelligent processor-based platform may have data on other nearby companies (i.e., scheduled or potential luncheon service locations) and may notify employees in those nearby companies that the MOU will be at that location early to serve customers. The intelligent processor-based platform may identify several possible courses of action and allow the MOU operator to select the best course of action.

The intelligent processor-based platform and luncheon sub-process dynamically assesses supply and demand throughout a day and determines how to proceed in the best interest of customers and the food truck operator. The intelligent processor-based platform may have one application, process, or software for the luncheon business and a different or unique application, process, or software for an evening business. However, there may be common steps in the evening process and in the luncheon process. Moreover, an intelligent processor-based platform may provide the evening consumers and the luncheon customer a similar end-to-end customer experience.

In the basic process flow, there will be fundamental similarities between the luncheon customer process and the evening consumer process. In many cases, the customer and the evening consumer may be the very same party, who are just ordering for different meals at different locations.

In one embodiment, there are both process and communications commonalities. The communications commonalities create familiarity and ease-of-use by the consumer. For example, language and terminology, page layouts, formats, fonts, etc. will be common to create a common end-to-end consumer experience.

The luncheon sub-process is rooted in the same key conceptual elements and steps as the evening or dinner process:
(1) customers place an “Order Request” and, as soon as possible thereafter, the intelligent processor-based platform advises them of a “Committed Fulfillment Time” for the order;
(2) both luncheon and dinner processes include an intelligent, software-driven capability to dynamically determine and exploit ongoing supply-demand gap opportunities; and
(3) based on moment-by-moment supply-demand intelligence, the processes include driving JIT customer-targeted activities and JIT internal operations so that the consumer will receive just-out-of-the-oven order, such as a bubbling hot pizza.

The current food-delivery industry delivery model cannot compare to a just-out-of-the-oven food product offer. The current model requires the food (e.g., pizzas) to be cooked at a remote location and then driven to the consumer for delivery. The best that the industry can do today is to get the pizza to the consumer as fast as possible once it is cooked and to keep the pizza as hot as possible during transport. However, current vendors cannot offer just-out-of-the-oven or bubbling hot food. For the luncheon customer business, the process and technology described herein allow a food truck operator to uniquely offer just-out-of-the-oven or bubbling hot food to consumers who pre-order. Additionally, the food truck operator can serve consumers who do not pre-order and are willing to wait in line for walk-up orders.

Similar process steps in the evening/dinner and the luncheon business include, for example:
(1) “Any-Time Ordering” that allows orders to be accepted up to and including just prior to the food truck's departing a location or service area;
(2) For “Requested pre-Orders,” the intelligent processor-based platform provides a confirming “Order Fulfillment Commitment Time;” and
(3) the intelligent processor-based platform makes continuous supply-demand assessments.

In the case of an evening business, the intelligent processor-based platform's supply and demand focus is on the locations and delivery times for a number of disparately-located consumers. In the evening business process, customer demand tends to be the key operating issue when compared to supply requirements. The intelligent processor-based platform balances the demands of customer location and customer requested timing versus the food truck's most recent location. From an operations point of view, a single high-temperature oven may be adequate for the evening business.

In the case of a luncheon business, the intelligent processor-based platform's supply and demand focus is on customer-order fulfillment time and food truck operator commitments at a given luncheon location. Additionally, the intelligent processor-based platform and luncheon sub-process specifically considers (1) oven capacity, (2) customer order types, and (3) customer commitment timing. In one embodiment, where a pizza food truck serves a business location, customers may be likely to order slices (as opposed to whole pizzas). Accordingly, a group of order requests may be organized into common work clusters for an efficient approach to producing offer just-out-of-the-oven or bubbling hot food. This allows the food truck to make available just-out-of-the-oven or bubbling hot food, such as pizza slices, for several customers if the orders do not comprise too many different ingredient pizzas. For example, customer orders for pizza slices that have the same or similar ingredients may be combined into one pizza pie so that the orders may be prepared and cooked at the same time. The pizza pie may then be cut into slices representing the individual orders.

The intelligent processor-based platform and luncheon sub-process organizes chef workload and provides JIT cooking instructions in order to:
(1) more readily provide just-out-of-the-oven or bubbling hot food to individual customers;
(2) generate simplified and/or streamlined chef instructions; and
(3) reduce the number of unsold items, such as pizza slices, that would not be considered just-out-of-the-oven or bubbling hot food.

Unlike the evening business process, from an operations point of view in the luncheon process more ovens may be required or desired; however, there is a practical limit to the number of ovens that a food truck can physically accommodate. The cost of additional ovens may also limit the number of ovens used by a food truck operator. Hence, the organization of work by the intelligent processor-based platform and luncheon sub-process is an advantage to the luncheon process and serves to differentiate the process from a dinner service.

In addition to considering supply-demand issues for a given luncheon location, the luncheon sub-process may also consider dynamic demand variations among proximate luncheon service locations.

After receiving a customer order, the intelligent processor-based platform communicates a committed fulfillment time for the order to the customer. The intelligent processor-based platform also generates JIT customer status communications as needed, such as confirming an order fulfillment time or notifying the customer of revisions to the order fulfillment time. Additionally, the intelligent processor-based platform generates JIT chef instructions for the order.

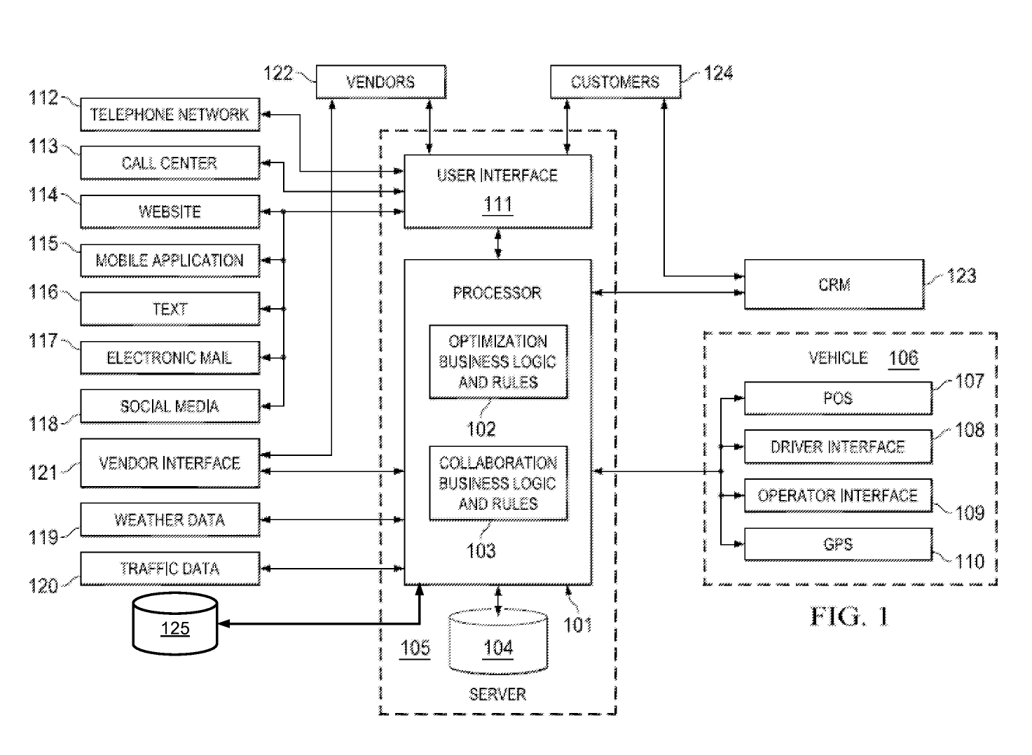

FIG. 1 is a high level block diagram illustrating a system 100 for providing intelligent processor-based platform and luncheon sub-process for food delivery truck operators according to one embodiment. A software or firmware application runs on a processor 101, which may be any logic circuitry configured to execute software code or program instructions. For example, software code for optimization business logic and rules 102 and collaboration business logic and rules 103 may run on processor 101. Software code and other data that is required by the automated optimization/collaboration application are stored in a database or memory 104, which may be any form of volatile or non-volatile electronic storage, such as a hard drive, cache, RAM, ROM, or flash memory. In some embodiments, the components, such as processor 101 and memory 104 are in a fixed location, such as on a server 105. In other embodiments, the components may be located on-board the food delivery truck or other vehicle 106. The components may communicate via direct or networked connections, such as wired connections or wireless connections supported by a packet-switched local area or wide area network.

Processor 101 is connected to a point of sale (POS) system 107 that is used to facilitate customer transactions, process credit and debit charges, and track customer orders. In one embodiment, to avoid the need to handle cash or other payment receipts, the luncheon sub-process is configured to receive any and all types of electronic payments. For example, the POS system 107 or any other payment system may be used to accept customer payment using a pre-established customer account or transaction-specific electronic payment. The food truck may accept any form of electronic payments or electronic currency, such as virtual money or BitCoins. Customers may pay when they make a pre-order, via an established account, credit/debit card, or other means, including a mobile device. Alternatively, the customer may pay later, such as when the order is received.

A driver interface 108 provides output, such as route information, to the food delivery truck driver. Driver interface 108 may provide information in various formats, such as printed driving directions or a visual display. Driver interface 108 may be coupled to a vehicle navigation or telematics system to provide visual route information on a map display and/or audible driving cues to the driver. Operator interface 109 provides order information, cooking instructions, and other directions to the staff in the food delivery truck who are cooking the food and other products. These instructions may identify, for example, the items in a customer's order and indicate when the items should be prepared. A navigation system, such as GPS 110 may be used to track the food delivery truck's current location, which allows the system to constantly update routing in order to avoid accidents, heavy traffic, and other potential delays.

POS system 107, driver interface 108, operator interface 109, and GPS 110 may be mobile components that are located on a delivery truck 106. These may be separate components or combined into one or more devices. In some embodiments, the other components, such as processor 101 and memory 104, may also be located on the food delivery truck. In other embodiments, the processor 101 and memory 104 are embodied in a fixed location such as a server 105. A number of delivery trucks 106, such as fleet of trucks controlled by the same operator or a number of independent trucks, may use the same central server 105.

A storage, such as memory 104, or any other operator-owned or third-party internal or external memory, storage, or database 125 may be used to store a list of scheduled businesses, businesses to be scheduled, businesses that have agreed to be scheduled but designated as a backup or alternate because of insufficient current capacity, and potential business customers. Such storage may also hold employee and customer identification and contact data.

Database 104 and/or 125 may include information about current customers, such as order histories, product and service preferences, payment information, contact information, etc. Database 104 and/or 125 may further include information about potential customers, such as employee lists for scheduled and targeted business locations, or contact information from any other source.

User interface 111 provides customer and operator access to system 100 via one or more technologies. The operator and customers may communicate by telephone via a telephone network 112 and/or call center 113. Alternatively, the customers and operator may communicate electronically, for example, via an Internet web site 114, mobile device application 115, text message system 116, electronic mail 117, or social media application 118.

Additional information may be available to processor 101 and to the software code for optimization business logic and rules 102 and collaboration business logic and rules 103, such as weather data 119 and traffic data 120. The weather data 119 may include forecast and current weather that is used to schedule future deliveries and to adjust drive times and routing for current deliveries. Similarly, the traffic data 120 may be used to determine delivery routes and to calculate estimated delivery times. The system 100 may also use the traffic data to reroute the delivery truck as updated traffic conditions are reported.

System 100 may also allow the user to access a vendor interface 121 that is used to place orders for new products and supplies. Vendors 122 may use vendor interface 121 or user interface 111 to access the system and/or to provide data, such as for supplies, products, stock, inventory, or other information.

The user may also access a customer relationship management (CRM) system 123. CRM 123 may be used to manage interaction with customers 124. The customers 124 may also access the system via user interface 111, such as to request service, place orders, provide contact information, view product information, update requests, verify order status and the like.

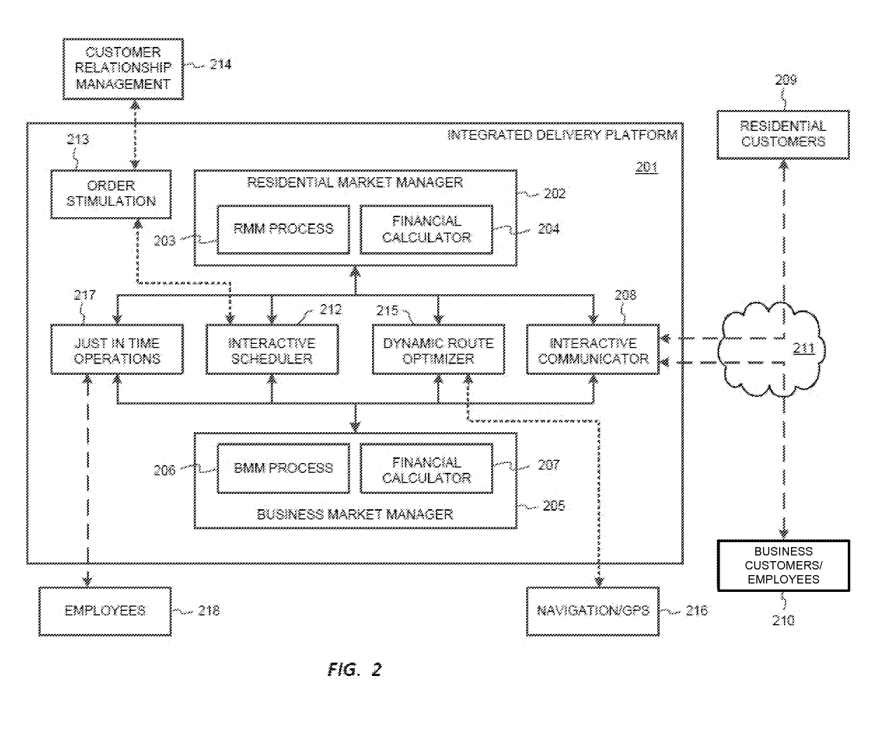

FIG. 2 illustrates an integrated delivery platform 201 according to one embodiment that provides delivery services to multiple markets, such as a residential market and a business market. In one embodiment, the integrated delivery process may be used to provide luncheon service to customers at office buildings, business locations, and other workplaces. The integrated delivery platform 201 may be comprised of a number of software modules or components on a processor-based system, such as a server or a desktop, laptop, or tablet computer. The residential market may include, for example, customers who order for deliver to homes, apartments, dormitories, and other single- or multi-unit dwellings. The business market may include, for example, single business locations, office towers, shopping centers and malls, educational institutions, hospitals, and other commercial and non-residential locations. It will be understood that platform 201 may serve a single operator and/or single delivery vehicle or may serve a number of vehicles belonging to one or more operators.

A residential market manager module 202 is responsible for managing data, schedules, territories, and interactions for residential customers. A residential market manager (RMM) process sub-module 203 provides intelligence for the residential market and controls how and when deliveries to this market occur. Financial calculator sub-module 204 is configured to provide economic analysis specifically for the residential market so that the residential market manager can maintain optimal financial performance when committing to customer orders and selecting delivery routes. Similarly, a business market manager module 205, business market manager (BMM) process sub-module 206, and financial calculator sub-module 207 provide corresponding operations for business customers.

The residential and business market manager modules 202, 205 interact with a number of other modules that provide specialized functionality. An interactive communicator module 208 provides a communication interface between platform 201 and residential customers 209 and/or business customers/employees 210, which include employees at business locations. The interactive communicator module 208 may provide a communication portal to users via one or more of telephone, email, text, social media, websites, smartphone applications, or any other media appropriate for access network 211. Interactive communicator module 208 is used to initiate, receive, and/or confirm customer requests, negotiate alternative delivery times, provide customer request status updates, contact potential customers to stimulate additional requests, and any other communication between the platform 201 and the customers.

An interactive scheduler module 212 assists in scheduling customer requests, proposing alternative delivery times, and identifying times for potential new request stimulation. The interactive scheduler may work with an order stimulation module 213 that identifies target customers to generate additional delivery requests. A customer relationship management (CRM) module 214 may also be used to identify current or potential customers for new business stimulation. Customer relationship management module 214 may be part of platform 201 or may be a separate system.

Dynamic route optimizer module 215 works with the interactive scheduler module 212 to create an initial baseline route plan. The dynamic route optimizer module 215 also provides updates to the route plan to serve additional customer requests. The dynamic route optimizer module 215 may use information from a navigation or GPS system 216 to determine a current location of a delivery vehicle. The navigation or GPS system 216 may be part of the integrated delivery platform 201 or may be a separate component that directly or indirectly provides location information for one or more delivery vehicles.

Just-in-time operations module 217 provides instructions to MOU employees 218. The instructions may include, for example, route information, driving directions, product preparation instructions, point-of-sale information for deliveries, and any other appropriate information. The MOU employees may interact with the integrated delivery platform 201 via a just-in-time module 217 interface, which may be a graphical user interface (GUI), keypad, printer, or any other visual, audio, or haptic interface.

Vendors 219 may also provide inputs to—or receive instructions from—integrated delivery platform 201. Vendors 219 may interact with just-in-time operations module 217 and/or interactive communicator module 208, for example.

The integrated delivery platform 201 further includes software code or module for optimization business logic and rules 220 and collaboration business logic and rules 221. Storage 222 is used to store information required by the integrated delivery platform 201, such as customer lists, schedules, map and routing information, inventory, product information, and the like.

At a high level of abstraction, the integrated delivery platform supports a two-step process: (1) initialization, and (2) ongoing management. Both steps have as the same business goals, which are to maximize revenue while minimizing costs, and to meet the customers' timing and other expectations. Overall, the process treats every minute wasted as a lost business opportunity and, therefore, is designed to provide route optimization, minimize windshield time (or other dead time between deliveries), and continually stimulate additional demand for any open slots. These concepts apply equally to all market segments—business, residential, special events, etc.—but may be executed in different ways in operation.

The market managers 202, 205 are configured so that if slots open up after initialization, then those slots are filled quickly. In one embodiment, the market managers 202, 205 may identify pre-qualified customers or high-interest targets that can be contacted on short notice to fill newly opened slots and, therefore, minimize otherwise lost time and sales. To anticipate and account for inevitable changing conditions, the platform 201 continually maximizes the revenue-capability of the operator and delivery vehicle(s) throughout the business day. If any time slots become available for any reason, the integrated delivery platform attempts to fill the slot quickly with the best next alternative and to seek continual revenue production at the least cost.

For example, business market manager 205 maximizes revenue opportunity per day while concurrently minimizing dead time through explicit consideration of potential revenue at each location and route optimizations between locations. Additionally, manager 205 pre-positions additional targeted customers for dynamic replacement of canceled orders or other schedule “holes.” The targeted customers are added to the schedule using dynamic and interactive scheduling. In one scenario, when an existing business customer closes or moves out of the territory, then a permanent slot is opened and new potential customers should be pre-identified so that they can be contacted to fill the cancelation slots. In other scenarios, existing customers may be offered additional visits, such as a second visit in a given month, to quickly fill the cancelation slot.

The platform would be ready to target other customers in close proximity to the cancelation client using targeted stimulation such as by sending out inquiries to a set potential back-fill clients. The back-fill clients set may be selected using optimization considerations based upon, for example, a distance from the canceling customer, and a customer-base size (e.g., number of employees at location) relative to the slot that became available. The interactive scheduler and interactive communicator may identify and communicate with the target back-fill customers in an iterative process to fill any revenue gap.

Other embodiments include methods for delivering items to a number of customers. An initial delivery schedule is established by a delivery service provider. The initial delivery schedule comprises a number of slots representing committed delivery times and delivery locations for the customers. The items are intended to be delivered to each of the customers at an assigned delivery location no later than the committed delivery time.

The delivery service provider may determine that the committed delivery time for a selected customer is not economically optimal, such as a delivery that would require an extra trip or that would make it difficult to meet other delivery commitments. The delivery service provider may offer the selected customer an alternative delivery time that is later than the committed delivery time. For example, the alternative delivery time may be chosen to reduce delivery costs associated with the selected customer, such as a time that can be fit into an existing schedule without requiring an extra trip or extra delivery vehicle. The initial delivery schedule may be revised if the selected customer accepts the alternative delivery time.

In other embodiments, a neural system is used to continuously access supply and demand for the delivery of items to customers. The neural system identifies conflicts among customer requests for delivery and/or identifies open slots in a delivery schedule. The neural system identifies target customers that may fill the open slots. The target customers are selected from a list of potential customers based upon the target customers' locations and the locations of existing customers. The neural system contacts the target customers to stimulate additional delivery requests to fill the open slots.

The neural system may comprise, for example, a processor operating as a “brain” that continuously obtains relevant data, such as a current schedule and potential customers. The processor assesses that data and makes decisions to further optimize the schedule. The brain triggers actions to stimulate additional delivery request from the potential customers.

A practical application of the luncheon business is differentiated from existing food truck services by an integrated combination of the following steps: (1) electronic ordering/payment, (2) a simple, new logical “production process approach” or “clustering” and (3) electronic customer fulfillment communications. These three steps are performed together as a sub-process of a luncheon business to provide two uniquely important customer benefits: (1) an customer spends virtually no waiting-in-line time to get served his/her desired food product, and (2) the customer receives “Just-Out-of-the-Oven” food, such as a “Bubbling Hot” pizza.

This component of the luncheon service, coupled with an evening delivery service, allows customers to receive “Just-Out-of-the-Oven Bubbling Hot” pizza at their place of work with no luncheon period waiting-in-line and at their residence with no guessing when their pizza will arrive. Customers may order and pay using a smartphone, tablet, or other mobile device.

The objective of the “production process approach” is to meet the customer's expectations of a “Just-Out-of-the-Oven Bubbling Hot” pizza and no-waiting-in-line while also ensuring an efficient company process. The “production process” is rooted in individual business, location-by-location, real-time customer demand on each given day. Based on that demand (i.e., customer orders), the orders are logically clustered into like categories. For example, all plain pizza orders, all pepperoni pizza orders, etc. are clustered together. Using this technique, and with consideration for oven capacity, fulfillment time commitments can be given to each customer. This results in both (1) virtually no waiting in line for the customer, and (2) the customer receiving “Bubbling Hot” pizza, instead of just warm or re-heated pizza slices. There is no limit to number of order clusters. Once cluster may be “general service,” such as a wait-in-line service.

The production clustering is an internal company activity managed by an intelligent processor-based platform. The customer is not specifically aware of this background process. In addition to providing real-time customer communications, the intelligent processor-based platform also provides just-in-time chef or cook instructions via an on-board display or tablet.

This sub-process can make a meaningful difference for customers. Some customers will value the “no-waiting-in-line” benefit and others will value the “Bubbling Hot” benefit. The customers who avail themselves of the pre-order approach will all benefit from reduced time waiting in line. Additionally, other customers, including those who simply take the general service (i.e., without pre-ordering), will have reduced wait time.

The food truck operator may provide both the luncheon sub-process as described herein for customers at work locations in addition to an evening service or dinner sub-process for customers and consumers at home or other locations. These processes may be for one food truck/MOU or for many MOUs.

The processes may be applied to an individual “tight” geography, such as a franchise territory, or may be for any size geographical area, such as a sub-component of a city, a city, or a larger or unlimited geographical area. In a larger territory case, there likely would be many MOUs. They may be, for example, assigned to sub-geographical areas, or may be “floaters” or MOUs that the intelligent processor-based platform efficiently and dynamically assigns to customers, based on locations of orders.

The process may be for any product delivery, to include cold or hot food. When delivering hot food, it may be partially or completely cooked on route or at an end location.

The intelligent processor-based delivery platform or some of its individual components may be processing orders continuously or periodically.

The intelligent processor-based delivery platform may interact with internal and/or external databases to service the customer orders and to stimulate new orders. The databases may be internal to the company/operator and/or external to the company/operator. Any database now existing or later developed or other sources of data, such as Facebook or Dun and Bradstreet, may be accessed by the intelligent processor-based delivery platform.

The food truck operator or other user may provide input to the intelligent processor-based delivery platform.

In addition to serving customers at a business location and customers at a home location, customer may request to pickup their order at a location that is not their home or business location.

The intelligent processor-based delivery platform communicates in a one-way (e.g., broadcast) and/or two-way (e.g., interactive) manner with customers in real-time and/or periodically.

The intelligent processor-based delivery platform communicates in a one-way (e.g., broadcast) and/or two-way (e.g., interactive) manner with food truck operators, chefs, cooks, etc. in real-time and/or continuously.

The intelligent processor-based delivery platform may provide data feeds for any or all company/franchisee purposes, such as for booking, ordering, accounting, franchisee and company management reports, customer satisfaction surveys, and the like.

Delivery locations may include more than just businesses at lunchtime or to residences in the evening. For example, the food truck operator may deliver to recreational facilities (e.g., a youth soccer or baseball field), to a school, or to a business location for an evening business function. The food truck operator or franchisee may become aware of such events and may schedule into the intelligent processor-based delivery platform to be developed as potential customers and orders.

The intelligent processor-based delivery platform may stimulate demand with particular time and/or location specificity. In one embodiment, company/operator-initiated demand stimulation may occur at any time, either before a baseline schedule has been prepared for the day or after. In other embodiments, a customer may initiate demand stimulation. In further embodiments, company/operator-encouraged demand stimulation, such as “neighbor programs” or “food truck locator” services may be offered.

Although embodiments of the invention are described with respect to a luncheon business, it will be understood that the process may be applied to any period of time, such as a breakfast, dinner, or break-time service at a business location.

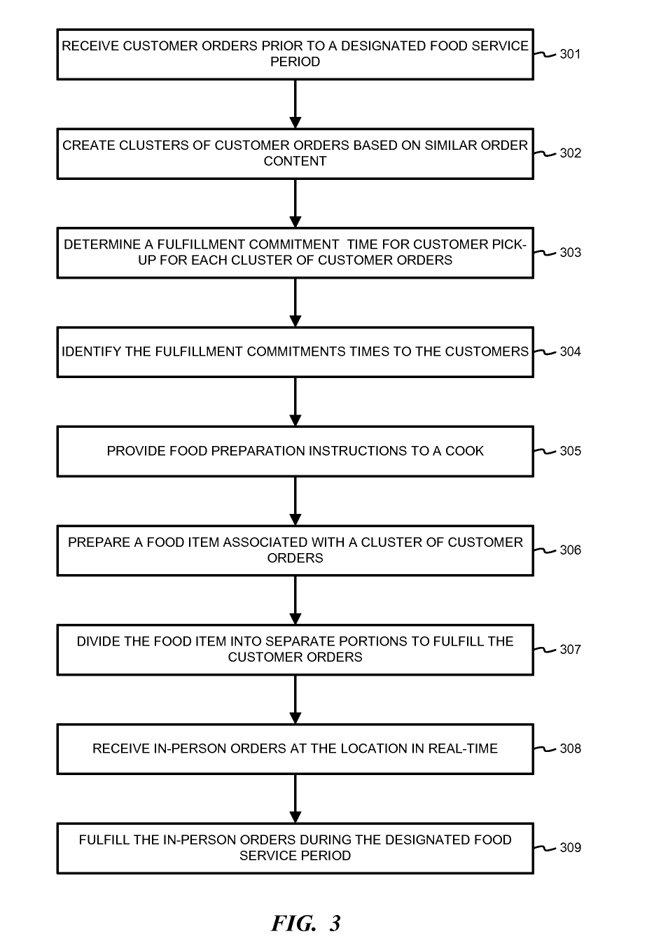

FIG. 3 is a flowchart illustrating a process for providing food service to customers at a selected location according. The process is executed by an intelligent, processor-based platform in one embodiment. In step 301, customer orders are received from customers prior to a designated food service period. A communication module on the intelligent, processor-based platform may be used to communicate with the customers. The designated food service period may be a luncheon food service, for example. The customer orders may be received via one or more of a telephone call, electronic mail message, facsimile, text message, and communication from an application on a customer smartphone, tablet, or computer. Customer payment instructions may be received with the customer orders, which allows for delivery of completed orders to customers during designated fulfillment commitment times without requiring further delay for payment.

In step 302, the intelligent, processor-based platform creates clusters of customer orders based on similar order content. In one embodiment, a scheduler module in the intelligent, processor-based platform may be used to create the clusters of orders. In step 303, a fulfillment commitment time for customer pickup during the designated food service period is determined for each cluster of customer orders. In other embodiments, the customer orders are not combined into clusters. Instead, each order may be treated individually and each customer assigned their own fulfillment commitment time for order pickup.

In step 304, the fulfillment commitment times are identified to the customers. Additionally, if the intelligent, processor-based platform may notify customers of modifications to the designated food service period at the selected location. For example, the intelligent, processor-based platform may determine whether to modify the designated food service period at the selected location based upon a number of current or anticipated orders for the selected location or based upon a number of current or expected orders for a next location. The anticipated or expected orders may include, for example, a total number of orders for a given location, such as the number of actual orders received plus an estimated number of future orders. The estimated number of future orders may be determined using the order history for the location for a given day of the year, time of day, weather conditions, or other factors.

In one embodiment, a manager module in the intelligent, processor-based platform may be used to evaluate whether to modify the designated food service period. For example, if the number of current orders is lagging behind a number of anticipated orders, then the designated food service period may be shortened so that the operator may move to a new location. Alternatively, if the number of current orders has exceeded a number of anticipated orders, then the designated food service period may be extended to satisfy the additional order volume. Similarly, the number of actual, expected, or anticipated orders at a next location may be used to evaluate whether the operator should remain at a current location.

In step 305, food preparation instructions are provided to a cook. The instructions may be adapted to direct the cook to complete food preparation for each customer order in an associated fulfillment commitment time. In one embodiment, an operations module in the intelligent, processor-based platform may provide just-in-time instructions to an operator. The just-in-time instructions are for preparation of food items associated with a cluster of customer orders. In step 306, the food items associated with a cluster of customer orders are prepared. For example, a number of similar orders are combined in a cluster and then prepared at the same time (e.g., a number of pepperoni pizza slice orders are combined into one cluster and one or more pizzas cooked to satisfy that cluster of orders). In step 307, the food item is divided into separate portions to fulfill the customer orders.

In step 308, additional orders are received in-person orders at the selected location in real-time. In other embodiments, additional orders may be placed electronically during the food service period, such as when a food truck is serving customers during a lunch period. The orders are filled during the designated food service period in step 309.

It will be understood that the operator may provide inputs to modify, adjust, or override the intelligent, processor-based platform. For example, the operator may want to modify the clusters of orders or the fulfillment commitment times generated by the intelligent, processor-based platform. The operator may also modify the start and end times for a food service period for a selected location or modify the location, such as when a food truck or delivery vehicle breaks down or an operator or worker is ill. The operator may further modify the just-in-time instructions.

The systems and methods described herein may be used to provide products or services to customers at a selected location. The systems and methods may be provided, for example, using an intelligent processor-based platform. In one embodiment, food items may be provided by a mobile food truck as part of a lunch service at a target business location. Customer orders are received from customers prior to a designated fulfillment period. The designated fulfillment period is a window of time during which an operator intends to provide the products or services. For example, the designated fulfillment period for a food truck may be an interval for a lunch service (e.g., a time period around noon when most people would take a lunch break). The products may include food items such as when the designated fulfillment period is a mid-day food service. Other times may also be used, such as dinner times, break times, breakfast times, and special events.

The supply-demand capacity is assessed for the designated fulfillment period. Based upon the orders and operator capacity, a fulfillment commitment time is determined. The fulfillment commitment time is when the operator expects to provide the customer with the product or a service. The fulfillment commitment time is an interval or specific time during the designated fulfillment period. The fulfillment commitment times are identified to the customers for each of the one or more customer orders. For example, the fulfillment commitment times may be sent to the customers.

The customer orders may be received customer orders via one or more of a telephone call, electronic mail message, facsimile, text message, and communication from an application on a customer smartphone, tablet, or computer. The fulfillment commitment times may be identified to the customers by sending fulfillment commitment time information to the customers via a telephone call, electronic mail message, facsimile, text message, and communication to an application on a customer smartphone, tablet, and/or computer.

Customers may also be notified of modifications to the designated fulfillment period or the fulfillment commitment times, such as when food orders will not be complete at the time first indicated. The operator may determine whether to modify the designated fulfillment period at the selected location based upon a number of anticipated orders for the selected location.

The operator may identify excess capacity during the designated fulfillment period at the selected location. When the operator has excess capacity, he or she may then notify consumers located away from the selected location of a capability to provide products or services to them during the designated fulfillment period at the selected location. For example, if fewer than expected orders are received at a scheduled location, then the operator may promote additional business by notifying potential customers at nearby or other locations that the service is available.

The products or services may be provided by a mobile food truck in some embodiments. An operator may determine whether to modify the designated fulfillment period at the selected location based upon a number of anticipated orders for a next location. The operator may move to the next location if there are more orders expected or received for that location compared to a present location.

The operator may receive one or more additional orders during the designated fulfillment period. The intelligent processor-based platform may evaluate capacity to service the additional order for delivery during the designated fulfillment period. Fulfillment commitment times are assigned for any additional orders that can be serviced. One or more alternative options may be provided for additional orders that cannot be serviced.

Food preparation instructions may be provided by the intelligent processor-based platform to an operator. The instructions are adapted to complete product preparation, such as cooking instructions, for each customer order at a designated fulfillment commitment time.

Customer payments may be processed with the customer orders, and then the completed customer orders are delivered to customers during designated fulfillment commitment times.

The fulfillment commitment times may be windows of time within the designated fulfillment period. An updated fulfillment commitment time may be determined, such as a narrower time range within the window of time. The updated fulfillment commitment time may represent a specific time that the order will be ready for customer pickup. The customers are then notified of the updated fulfillment commitment time. The operator may determine that the original fulfillment commitment time cannot be met and then notifies the customers of an updated fulfillment commitment time.

The operator may receive additional in-person, telephone, or electronic orders during the designated fulfillment period from customers requesting products or services during the designated fulfillment period. These additional orders may be accepted and serviced by the operator depending upon the supply-demand capacity.

In another embodiment, food service is provided to customers at a selected location. One or more customer orders are received from customers prior to a designated food service period. Clusters of customer orders are create based on similar order content. A fulfillment commitment time is determined for customer pickup during the designated food service period for each cluster of customer orders. The fulfillment commitment times are identified to the customers.

A food item associated with a cluster of customer orders is prepared. The food item may then be divided into separate portions to fulfill the customer orders. Additional orders may be received during the designated food service period from customers requesting food items during the designated food service period.

In other embodiments, food service is provided to customers at a designated location within a predetermined service window using an intelligent, processor-based system. A communication module is configured to receive one or more customer food orders and to notify customers of fulfillment commitment times. A scheduler module is configured to assess supply-demand capacity for a designated fulfillment period and to determine a fulfillment commitment time during the designated fulfillment period for customer order pickup.

A manager module may be configured to continuously evaluate whether to modify the designated fulfillment period at the selected location based upon a number of current orders, a number of anticipated orders, or a number of stimulated orders. The manager module may be configured to evaluate whether to modify the designated fulfillment period at the selected location based upon a number of current or expected orders for a next location.

The communication module may be further configured to communicate with customers via one or more of a telephone call, electronic mail message, facsimile, text message, and communication from an application on a customer smartphone, tablet, or computer.

A point of sale module may be configured to electronically complete customer payment transactions.

In other embodiments, a system provides products or services to customers at a designated location within a predetermined service window. A communication module may be configured to receive one or more customer orders and to notify customers of fulfillment commitment times for each order. A scheduler module may be configured to create clusters of customer orders based on similar order content and to determine a fulfillment commitment time for each cluster of customer orders. The fulfillment commitment time may be within the designated food service period.

An operations module may be configured to provide just-in-time instructions to an operator. The just-in-time instructions may be directed to preparation of products associated with a cluster of customer orders and to dividing the products into separate portions to fulfill the customer orders.

An order stimulation module may be configured to stimulate additional customer orders for the designated location or for a future location.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1-15. (canceled)

16. A method for providing food service to customers at a selected location using an integrated delivery platform, comprising:
receiving, via an interactive communicator in the integrated delivery platform, one or more customer orders from customers, the orders related to a designated food service period;
creating clusters of customer orders based on similar food items in the order content;
determining a fulfillment commitment time for customer pickup during the designated food service period for each cluster of customer orders; and
identifying the fulfillment commitment times to the customers via the interactive communicator.

17. The method of claim 16, further comprising:
preparing a food item associated with a cluster of customer orders; and
apportioning the food item into separate portions to fulfill the customer orders.

18. The method of claim 16, further comprising:
receiving additional orders via the interactive communicator during the designated food service period from customers requesting delivery of additional food items during the designated food service period.

19-23. (canceled)

24. A system for providing products or services to customers at a designated location within a predetermined service window, comprising:
a processor configured to perform instructions; and
a storage media having stored thereon computer-executable instructions that, when executed by the processor, cause the processor to:
receive one or more customer orders and to notify customers of fulfillment commitment times for each order; and
create clusters of customer orders based on similar food items in the order content and to determine a fulfillment commitment time for each cluster of customer orders, the fulfillment commitment time within the designated food service period.

25. The system of claim 24, wherein the computer-executable instructions that further cause the processor to:
provide just-in-time instructions to an operator, the just-in-time instructions are directed to preparation of products associated with a cluster of customer orders, and to apportioning the cluster into separate portions to fulfill the customer orders.

26. The system of claim 25, wherein the computer-executable instructions that further cause the processor to:
receive operator inputs and to modify the clusters of customer orders, the fulfillment commitment times, the designated food service period, the designated location, or the just-in-time instructions.

27. The system of claim 24, wherein the computer-executable instructions that further cause the processor to:
stimulate additional customer orders for the designated location or for a future location.
